(19) United States
(12) Patent Application Publication
(10) Pub. No.: US 2005/0052418 A1
(43) Pub. Date: Mar. 10, 2005

(54) Ordinary computer mouse that is also a vertical mouse

(76) Inventor: Sassan Khajavi, Los Angeles, CA (US)

Correspondence Address: Sassn Khajavi, 1377 S. Beverly Glen, #202, Los Angeles, CA, 90024, US

(21) Appl. No.: 10/914,946

(22) Filed: Aug. 9, 2004

Related U.S. Application Data
(60) Provisional application No. 60/494,337, filed on Aug. 12, 2003.

(51) Int. Cl. G09G 5/08

(52) U.S. Cl. 345/163

(57) ABSTRACT

A personal computer mouse is disclosed that can be used both as a regular mouse as well as a vertical mouse. One or two tracking mechanisms are placed on the mouse such that the hand can go from being in the horizontal position (same orientation as if the hand was with the palm resting flat on a table top) to the vertical position (same orientation if the hand was in a hand-shake position).

### CROSS-REFERENCE TO RELATED APPLICATIONS

This application claims the benefit of U.S. provisional patent application 60/494337, filed Aug. 12, 2003, entitled “Combination Horizontal/Vertical Mouse”.

### BACKGROUND OF THE INVENTION

(1) Field of the Invention

This invention related to a personal computer input device known as the mouse.

(2) Description of Related Art

This invention is exactly like the invention disclosed in U.S. patent application No. 09/660,530 filed Sep. 13, 2000. The only difference is that the second tracking mechanism is placed on the right side of the mouse as opposed to the face of the mouse facing the user. Other related mouse apparatus, are:

U.S. Pat. No. 5,648,798 Hamling

U.S. Pat. No. 5,894,303 Barr

U.S. Pat. No. 6,907,372 Suzuki

U.S. Pat. No. 6,184,869 Harding et al.

U.S. Pat. No. 6,229,527 Sheam

U.S. Pat. No. 6,262,715 Sawyer

Mouse made by Evoluent Corporation on web site www.evoluent.com

### BRIEF SUMMARY OF THE INVENTION

Since the invention of the mouse more than thirty years ago many types of mice have been invented. All these mice have one problem: They force the user to use the same local group of muscles, joints and tendons of the hand. The same muscles, joints, and tendons are forced to repeat the same motions.

Repetition is the root cause of RSI (Repetitive Stress Injury). The invention disclosed is a mouse that can be alternated as a regular mouse and a vertical mouse, thus distributing the repetition to non-localized muscle, tendon and joint, and bone group. Distribution of the repetitious movements is the most effective way of minimizing RSI. Stress on the hand is reduced by as much as 40%.

### DETAILED DESCRIPTION OF THE INVENTION

The object of this invention minimizing the stress on the muscles, joints, tendons, and bones of the fingers, hand, wrist, and the lower arm while operating a computer mouse.

It is known that the continuous use of mouse may cause repetitive stress injuries. The repetitious use of a mouse can cause numbing, aching and tingling of the hand and lower arm. The long-term use of a mouse can cause

Carpal Tunnel Syndrome (CTS)

Tendonitis

Tenosynovitis,

De Quervain's Tendinitis

And other related disorders.

The invention disclosed herein, greatly reduces the chance of experiencing these conditions.

The most un-ergonomic aspect of a mouse is the fact that the lower arm must be literally twisted 90 degrees in order to operate it.

The hand and the arm are in the most comfortable and natural position when the arm is simply relaxed and allowed to “hang” by one's side. In this position the palm of the hand is oriented in the vertical plane. However, when the hand is using a typical computer mouse, the palm of the hand is forced to get twisted and be in the horizontal plane.

Currently vertical mouse do exist that impose less stress on the hand. An example of this mouse is the one manufactured by Evoluent Corporation. This mouse is more comfortable than the ordinary mouse, but it still does not address the root cause of RSI, which is REPETITION. This vertical mouse just like the horizontal mouse forces the hand and finger and the wrist to repeat the same motions over and over and over again.

The ideal mouse would be one that allows the user to distribute the stress by alternating the position of the hand in the vertical and horizontal position. Furthermore, different fingers operate the mouse when it is in horizontal position than when they are in vertical position.

This stress minimizing mouse invention has large commercial viability since it satisfies the point of parity requirement. This product is not a different product. It is a regular product plus. So there will be no buyer's remorse. Consumer always has the option of using it just like a regular mouse. This satisfies the brand requirement of having point of parity. This product is 2-in-1, with one being a conventional/horizontal mouse. No early adopters are even needed for this invention.

There is no need to adopt it; there is no need to adapt to it.

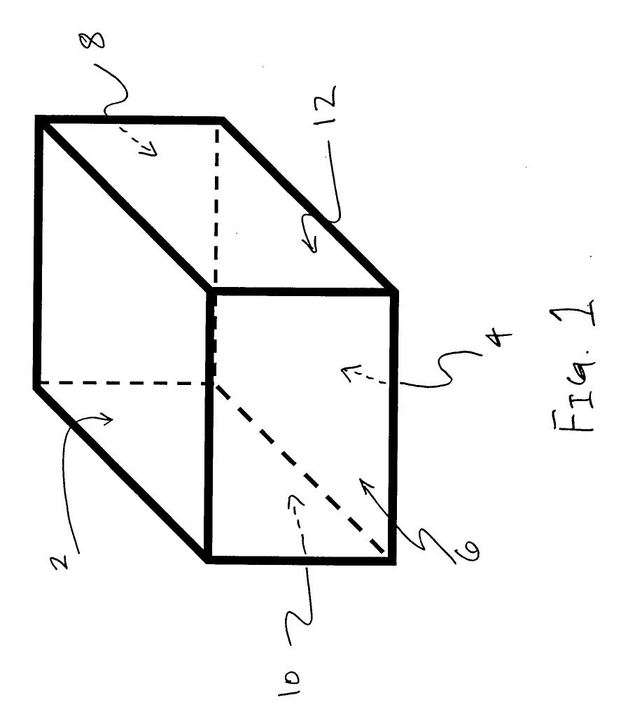

FIG. 1. Is a three dimensional object like a mouse. 2 is top, 4 is button (where the tracking wheel of a mouse is today), 6 is front (the face closest to the user while holding the mouse in hand), 8 is back (where the mouse cord usually attaches to in today's wired mice), 12 is right, and 10 is left face of the three dimensional object.

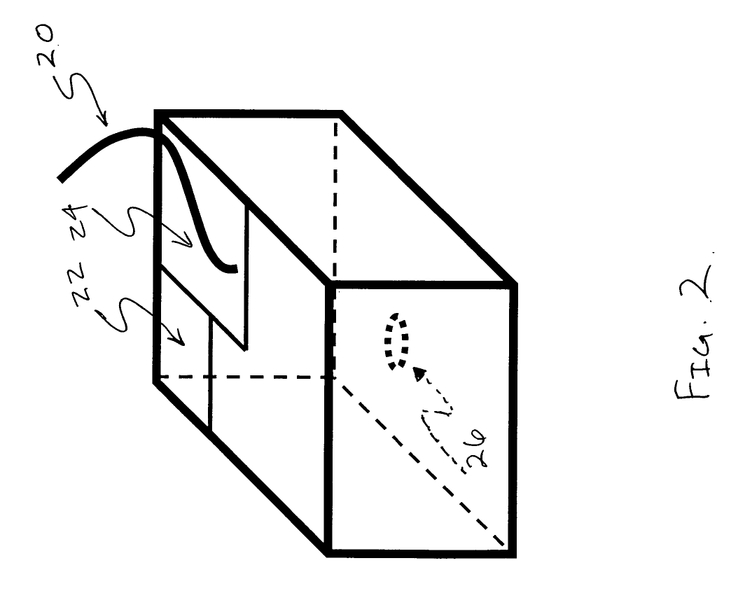

FIG. 2. This is a classic, regular, ordinary mouse. 22 is left click button (for a right handed person), 24 is right click button, 20 is mouse cord, and 26 is the tracking mechanism of regular mouse today. (There is only one minor difference: The left click button is slightly longer than the right click button. This is to ensure the right click button is not depressed by mistake, when trying to depress the right click button, when the mouse is being held in side vertical position).

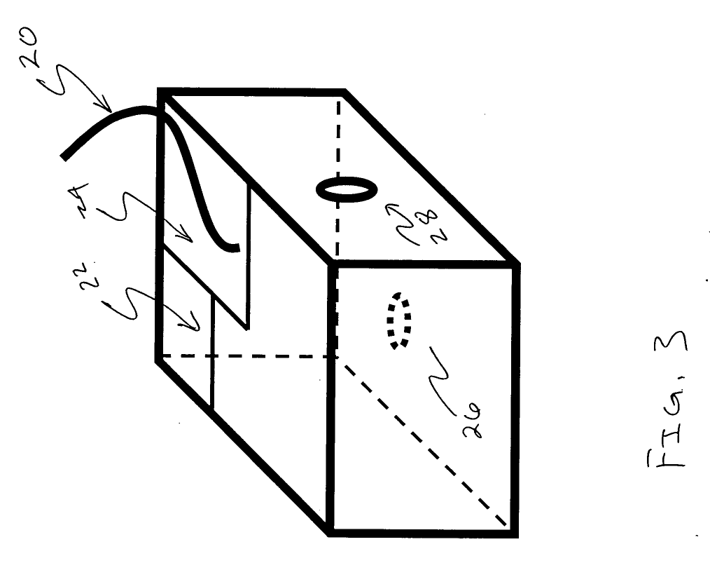

FIG. 3. This conceptual drawing is the very essence of the invention. Addition of a second tracking mechanism, 28 to the right side of a regular mouse (for right handed people). This simple, low-cost addition reduces the stress of the mouse by as much as 40%, by allowing alternating between two very opposite positions.

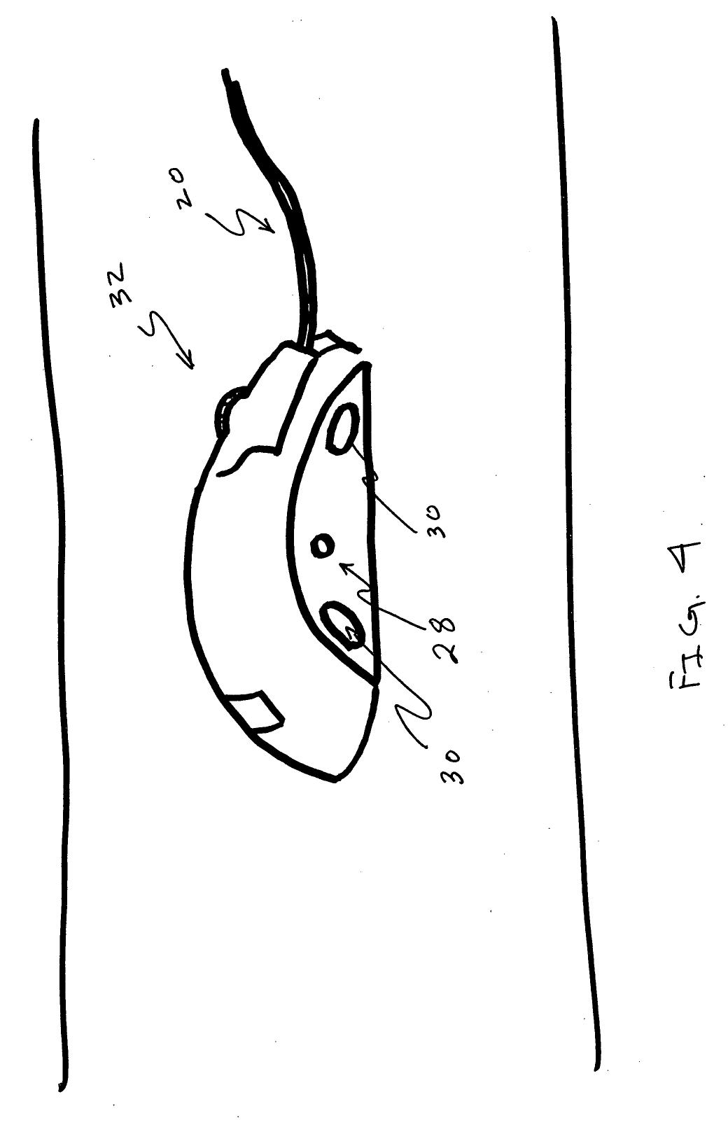

FIG. 4. This is same drawing as FIG. 3, however the drawing is more realistic than conceptual. It shows a regular mouse resting on a tabletop. 32 is the scroll wheel and 20 is the mouse cord. The new thing is the addition of additional tracking mechanism, 28 to the right side of the mouse. 30 is simply frictionless stickers to allow the mouse to glide smoothly on any surface when it is held in the vertical position.

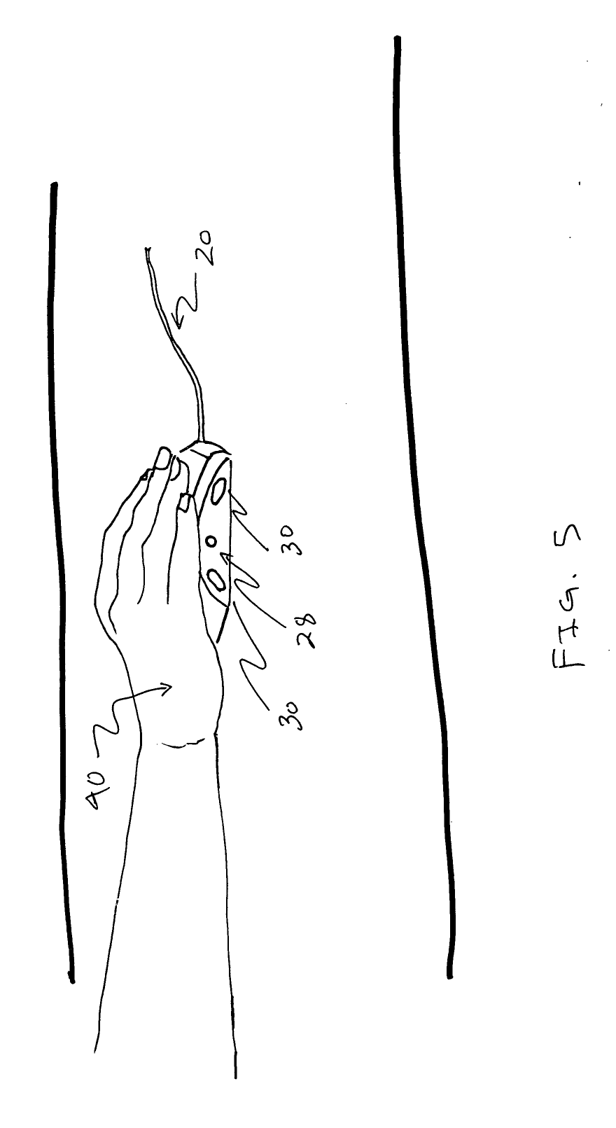

FIG. 5. 40 is a human hand holding the mouse in the horizontal position. The hand is twisted at the forearm.

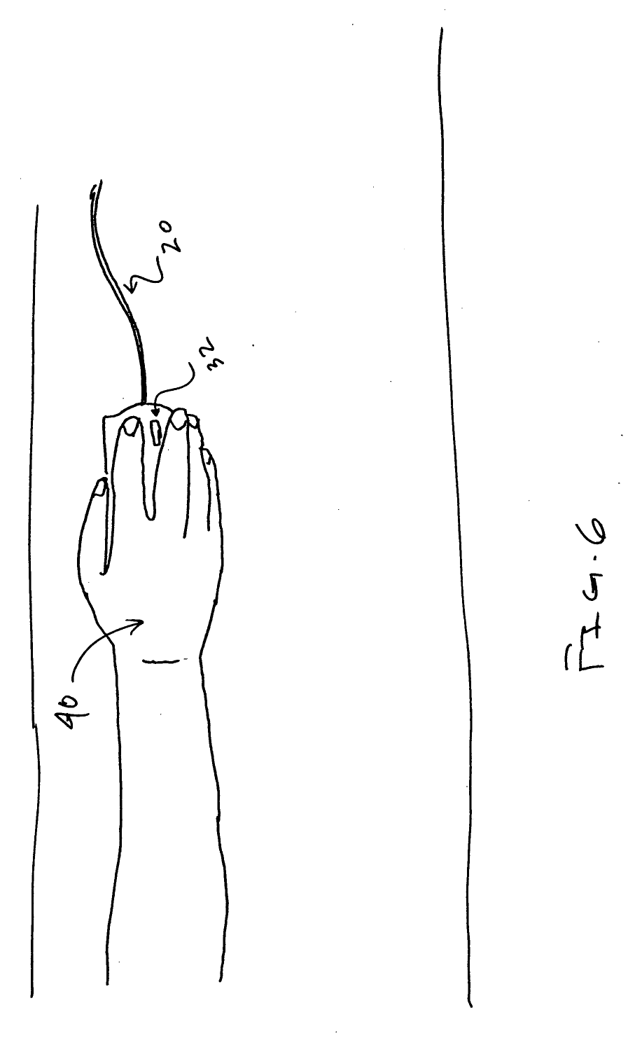

FIG. 6. When the mouse is turned so that the right side rests on the table top, then two things happen: First the forearm is now in a neutral/relaxed position, second, a different set of muscles, and joints will be used when performing motions related to the mouse use.

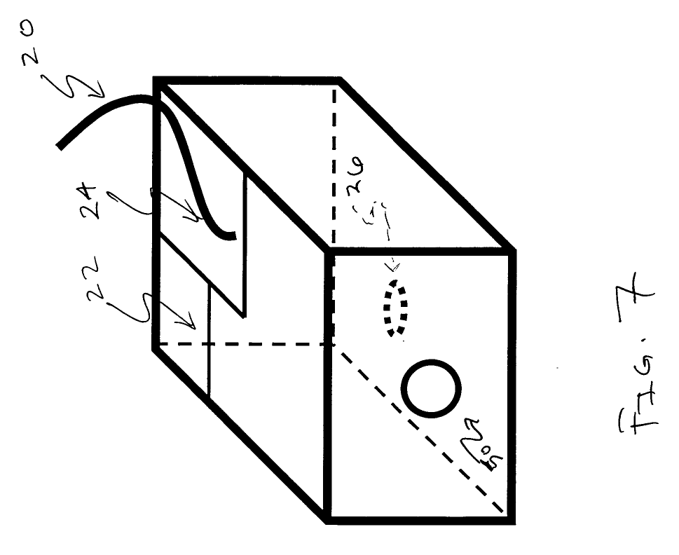

FIG. 7. Is another embodiment showing the tracking mechanism 50 being on the front side of the mouse. This arrangement also makes it possible to hold the mouse in a vertical position as in next figure.

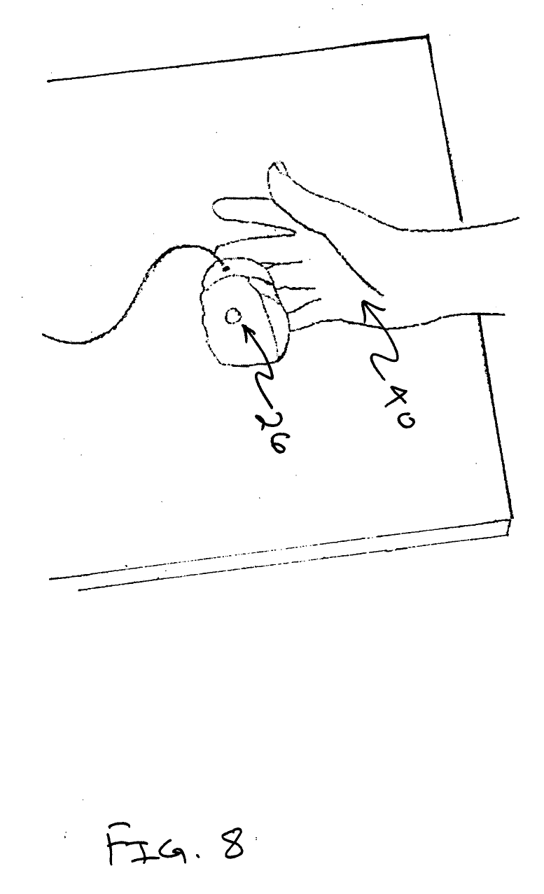

FIG. 8. Holding the mouse in horizontal position when the second tracking mechanism is at the front face of the mouse.

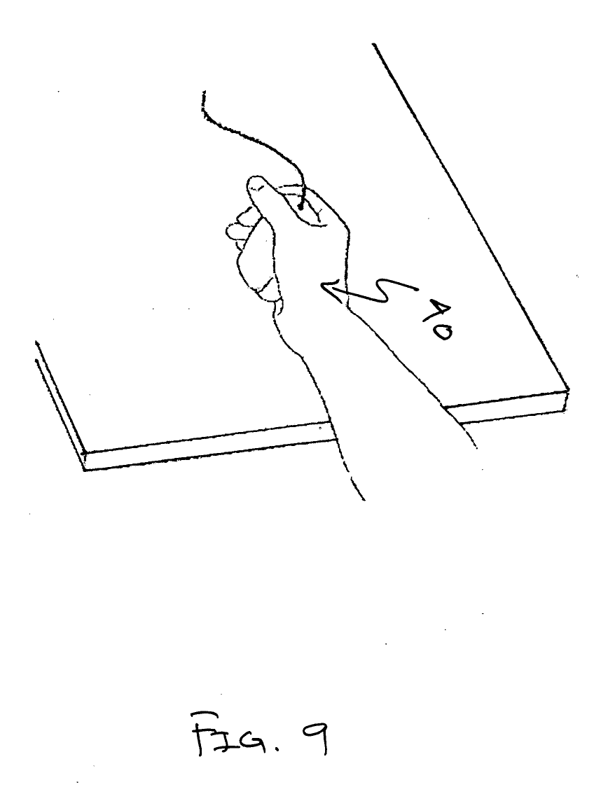

FIG. 9. Shows hand 40 in vertical position when the second tracking mechanism is at the front face of the mouse.

### Some Other Embodiments of the Invention

The above describes the concept of the product only. It is not meant to limit the scope of the invention. Obviously many variations and embodiments could be conceived and implemented. For example,

A. The tracking mechanism could be mechanical using roller ball or it could be optical.

B. The mouse could be wireless using radio communication with the computer.

C. The mouse could have an internal switch that is gravity operated to make it “understand” which tracking mechanism it should be using depending on whether it is in vertical position or horizontal position.

D. The mouse could have various contours on it to make it easier to hold when in both positions. The contours could conform to the position of the thumb as well as the other fingers of the hand.

E. The mouse could be designed for left handed people as well. In this case the second tracking mechanism used for vertical tracking would be placed on the left hand side of the mouse not the right hand side.

F. Instead of two tracking mechanism, it is possible to have a specially designed single mechanism unit that can be placed at the edge of the horizontal bottom side of the mouse and the vertical right side of the mouse. This type of arrangement may result in cost savings when manufacturing the mouse. However the principle is the same, that a mouse is invented that allows alternating between two positions about ninety degrees from each other. A mouse that allows the hand to alternate position maximizes comfort, by minimizing repetition on a local place on the hand.

G. It is also possible to have three mechanisms for tracking motion of mouse. One at the bottom, one at the front, and one at the right face. Now the mouse can be held in three different ways. One is horizontal and two are vertical. A slight gain is achieved in further distribution of repetition.

1. An ergonomic computer mouse comprising,
(a) a regular computer mouse having a first sensor for tracking said mouse's translation across a surface:
(b) A second sensor for tracking said mouse's translation across a surface
Said first sensor placed at the bottom surface of the mouse and said second sensor placed at the right side of the mouse in a plane substantially vertical to the said bottom surface of the mouse, such that the hand can use said mouse either in vertical or horizontal position.
